(19) United States
(12) Patent Application Publication
(10) Pub. No.: US 2010/0181043 A1
(43) Pub. Date: Jul. 22, 2010

(54) REGENERATIVE AIR PREHEATER WITH BRUSH SEAL

(76) Inventors: Ulrich Mueller, Edingen-Neckarhausen (DE); Ewald Kitzmann, Weinheim (DE); Volker Schuele, Leimen (DE)

Correspondence Address: ALSTOM Power Inc., 200 Great Pond Drive, P.O. Box 500, WINDSOR, CT, 06095, US

(21) Appl. No.: 12/311,021

(22) PCT Filed: Jul. 18, 2007
(86) PCT No.: PCT/EP2007/006374

§ 371 Date: Jan. 7, 2010

(30) Foreign Application Priority Data
Jul. 21, 2006 (DE) 10 2006 034 483.9

(51) Int. Cl. F23L 15/02; F16J 15/44

(52) U.S. Cl. 165/4; 277/355; 277/347

(57) ABSTRACT

A regenerative air preheater with brush seals (23) is proposed.

The invention concerns regenerative air preheaters comprising the features of the preambles of independent claims 1 and 2.

Regenerative air preheaters (APHs) have been known and proven in practice for decades. A particularly advantageous system is the so-called Ljungström preheater with a rotor which has one or more layers of heating elements.

In another system, known as the “Rothemühle” system, the APH comprises a stator with one or more layers of heating elements, a casing, and two turn caps. The casing consists of at least one flue gas inlet, at least one air outlet, at least one flue gas outlet, and at least one air inlet. The turning of the turn caps ensures that flue gas and air to be preheated alternately flow through all areas of the stator.

The invention is not limited to specific regenerative air preheater systems, but it can be successfully used in bisector, trisector and concentric air preheaters with several air inlets and outlets and several flue gas inlets and outlets.

The mentioned APH systems share the fact that the air to be heated is conducted in counterflow to the flue gases to be cooled through a casing having at least one air inlet, at least one air outlet, at least one flue gas inlet and at least one flue gas outlet. The heat is transported from the flue gas to the air via the heating elements of the rotor and/or the stator.

In both APH systems, the heating elements, whether located in the rotor or the stator, are exposed to variation in temperature. This leads to expansion and subsequent contraction of the heating elements and of the rotor and/or the stator.

This embodiment envisions sealing bars between the rotor and the casing and/or between the stator and the turn caps to prevent the air which is being preheated from mixing with the flue gas. Due to the thermal expansion described above, the size of the sealing gap is subject to frequent changes.

Two adjusting devices are known in practice to compensate for the changes of the sealing gap. One somewhat simpler variation, which is often used on the cold side of the air preheaters, has manually adjustable seals. This enables setting of a fixed sealing gap, which is, however, comparatively large due to the irregularities in and expansion of the rotating surfaces. Consequently, the sealing effect of these manually adjustable sealing bars is limited.

Another, much more complicated solution consists in automatically adjusting the sealing bars in a way that a minimal gap width is set at all times between the sealing bar and the component which moves relative to the sealing bar. This automatic regulation of gap width is not only very complicated but also error-prone, and existing air preheaters can often not be retrofitted with such systems due to lack of space.

The invention is based on the task of providing improved sealing for regenerative air preheaters which allows minimal gap widths and has a simple structure. Furthermore, the space required by the seal in accordance with the invention is to be small, so that existing air preheaters can easily be retrofitted with the seal in accordance with the invention.

According to the invention, this task is solved by envisioning the axial seals and/or the radial seals as brush seals in a regenerative air preheater comprising the features of the preamble of claim 1 and of the preamble of independent claim 2.

Brush seals are, for example, successfully used in steam turbines to reduce the leakage currents between the various stages of a steam turbine. They have a simple structure and usually consist of only one fixing bar, to which the bristles of the brush seal are fitted. The sealing effect is achieved by a multitude of bristles placed in close juxtaposition to each other.

At the same time, each individual bristle is so thin that the collectivity of bristles can resiliently absorb great deformation without becoming permanently deformed. Should individual bristles be permanently deformed during operation, the brush seal will still remain operative.

This enables reduction in the gap width between the brush seal in accordance with the invention and the component moving relative to the brush seal to zero or to a very small value.

If thermal expansion of the rotor or the stator should cause the brush seal to rub on the component moving relative to the brush seal, this is usually unproblematic, as there is room for the bristles of the brush seal to yield, so that the component to be sealed remains undamaged. In addition, rubbing on a component will not cause the bristles of the brush seal to deform permanently, but the bristles of the brush seal will spring back to their original position once the irregularity in this component has moved past the brush seal.

It has proven advantageous if the bristles of the brush seal are held in a fixing bar. Using a fixing bar makes it possible to fix the bristles in the fixing bar in a non-positive and/or firmly bonded fit, particularly by welding.

The bristles of the brush seal in accordance with the invention can be arranged so as to form an angle between 90° and 30° with the direction of the relative movement between the brush seals and the component to be sealed. If the bristles form an angle of 90° with the direction of the relative movement of the component to be sealed, the brush seal in accordance with the invention is relatively stiff. Inclining the bristles allows for the stiffness of the brush seal in accordance with the invention to be continuously adjusted and adapted in an optimal manner to the requirements of the conditions predominating at the place of operation.

Of course, the brush seals may also be designed to be manually or automatically adjustable.

To be able to endure the aggressive and corrosive conditions and the high temperatures inside an air preheater, it has proven advantageous to make the bristles of the brush seals of stainless steal. Of course, other corrosion-proof and elastically ductile materials can also be used to make the bristles of the brush seals in accordance with the invention.

In addition to the brush seals in accordance with the invention, conventional sealing bars may be envisioned to relieve the brush seals, wherein these sealing bars can then be fitted with a somewhat larger sealing gap, thereby facilitating assembly and increasing the life time of the sealing bars.

Of course, existing sealing bars can also be retrofitted with the brush seal in accordance with the invention. This is almost always possible, in particular due to the small space required. In this case, the adjustment devices in place can be taken over without further modifications, making retrofitting of brush seals not only highly effective but also very cost-effective.

Further advantages and advantageous embodiments of the invention will become apparent in the following drawing, its description, and the claims. All features described in the drawing, its description, and the claims can be essential to the invention both individually and in any combination.

In the drawing:

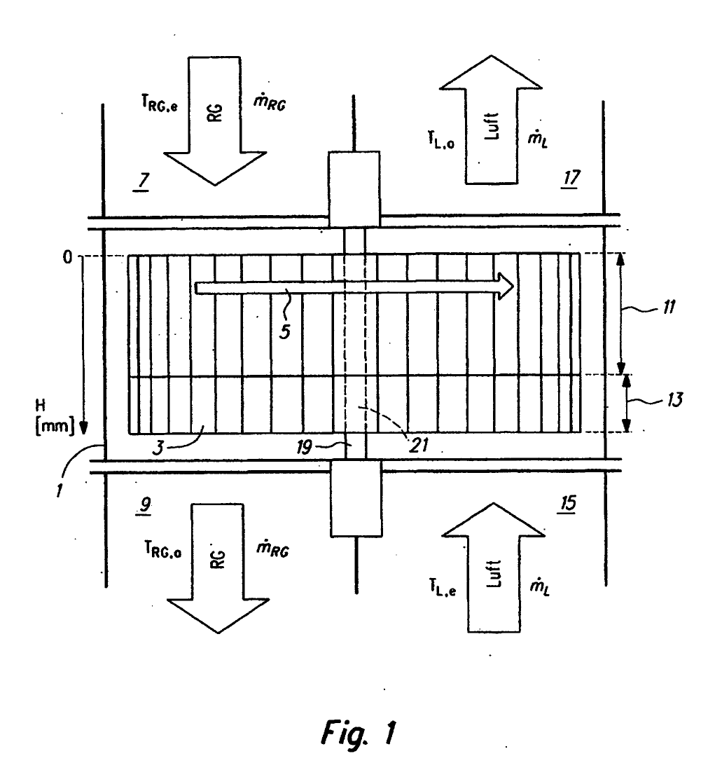

FIG. 1 shows a sectional, schematic view of a regenerative Ljungström air preheater,

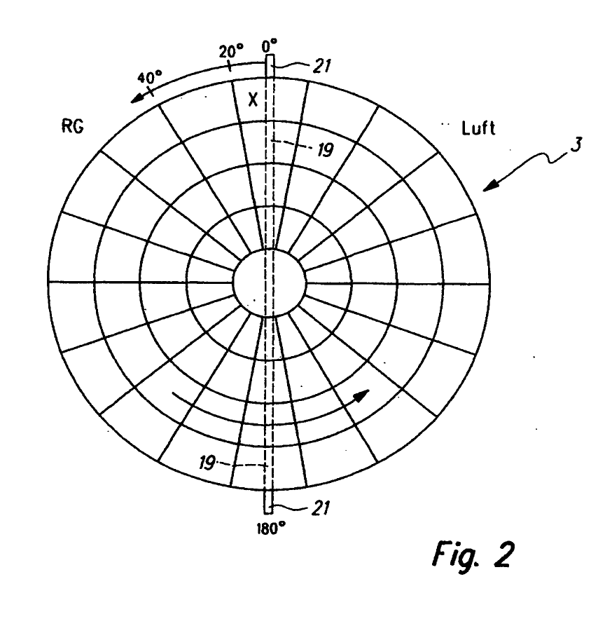

FIG. 2 shows a top view of a rotor of a regenerative air preheater,

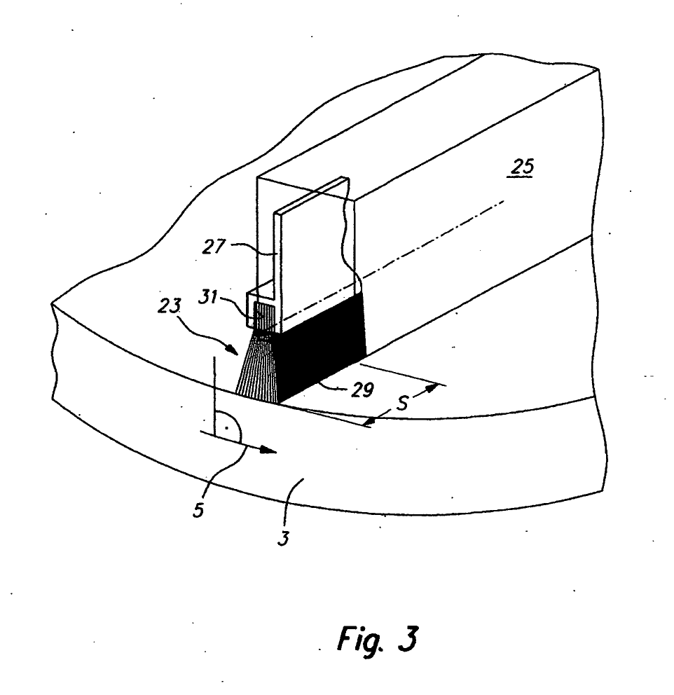

FIG. 3 shows an embodiment of a brush seal in accordance with the invention,

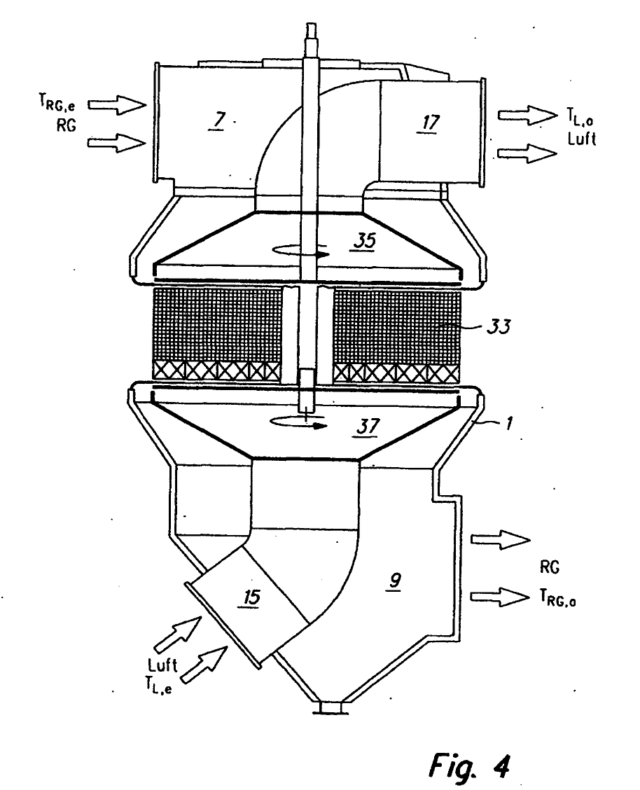

FIG. 4 shows a sectional, schematic view of a regenerative Rothemühle air preheater, and

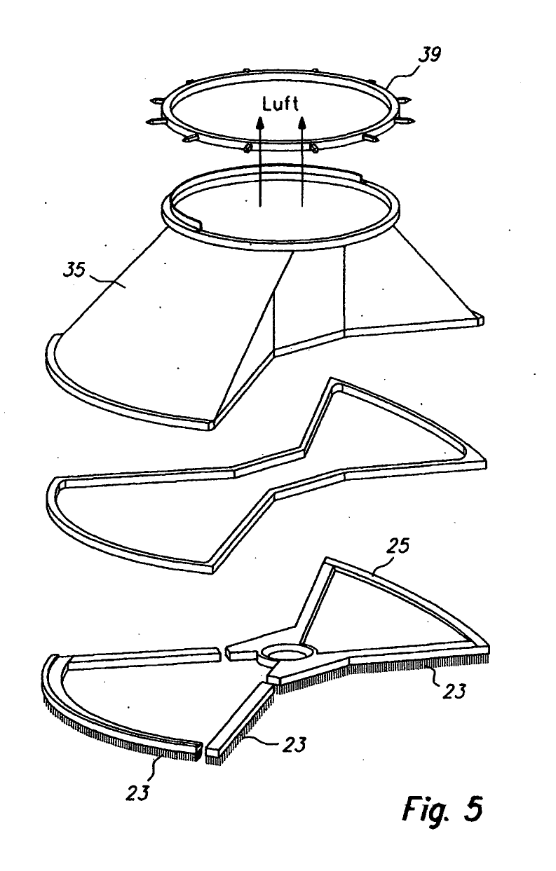

FIG. 5 shows an exploded view of a turn cap with a brush seal in accordance with the invention.

### DESCRIPTION OF THE EMBODIMENTS

FIG. 1 shows a side view of a regenerative air preheater and a sectional view of a casing 1. The casing 1 holds a revolving rotor 3 running on bearings. The rotor 3 can be set in rotation via drives which are not shown. The rotation of the rotor 3 is indicated by arrow 5 in FIG. 1.

The left half of the casing 1 is filled with flue gas (RG) flowing in the direction of the arrows. The flue gas enters the air preheater through a flue gas inlet 7 and leaves it through a flue gas outlet 9. The flue gas passes the part of the rotor 3 located in the left part of the casing 1 when passing from the flue gas inlet 7 to the flue gas outlet 9.

In the embodiment shown in FIG. 1, the rotor 3 has 2 layers of heating elements. The upper part of the rotor 3 holds the so-called hot layer 11 and the part below this holds the so-called cold layer 13.

The hot layer 11 and the cold layer 13 differ in material, surface coating, and geometry and are adapted in an optimal manner to the conditions in each case.

An air inlet 15 and an air outlet 17 are disposed at the right side of the air preheater as shown in FIG. 1. The direction of flow of the air which enters the air preheater through the air inlet 15 and exits it through the air outlet 17 is opposite to the direction of flow of the flue gas.

When flowing through the part of the rotor 3 that is located in the left part of FIG. 1, the flue gases convey heat to the heating elements of the rotor 3 and heat the hot layer 11 and the cold layer 13 of the heating elements. At the same time, the flue gases cool down. This means that an inlet temperature T_{RG,e} of the flue gas at the flue gas inlet 7 is higher than an outlet temperature T_{RG,a} of the flue gas at the flue gas outlet 9.

When moving from the left part of the air preheater as shown in FIG. 1 to the right part of the air preheater by rotation of the rotor, the thus heated heating elements heat the cold air and cool down. This means that an inlet temperature T_{L,e} of the air at the air inlet 15 is lower than an outlet temperature T_{L,a} of the air at the air outlet 17.

In conclusion, part of the sensitive heat contained in the flue gas is transferred to the air by means of the air preheater.

To prevent the flue gas and the air from mixing, axial seals 19 and radial seals 21 are envisioned between the left part of the casing 1 and the right part of the casing 1.

FIG. 2 shows a top view of the rotor 3 of FIG. 1.

It becomes apparent from this top view that the rotor 3 consists of different sectors with partition walls (tangential walls; without reference sign). These segments accommodate the heating elements in containers (not shown). If, for example, the heating element marked “X” turns towards the left part of the air preheater starting from the radial seal 19 at a rotation angle of 0°, the flue gas current existing there will flow around it and heat it. This process continues until the end of the gas sector at a rotation angle of 180°. At that point, namely, segment X exits the left part of the air preheater, passes between the axial seals 19 and the radial seals 21 while rotating, and enters the right part of the air preheater. There, the cold air flows around the then heated heating element, which conveys heat to the air. This process continues until the end of the air sector (rotation angle>180° and ≦360°) is reached.

In known state-of-the-art APHs, the axial seals 19 and the radial seals 21 are rigid sealing bars which must not make contact with the rotor 3, as the seals 19, 21 and the rotor 3 could otherwise be damaged. Therefore, a sealing gap (not shown in FIGS. 1 and 2) must be formed between the axial 19 and radial seals 21 and the rotor 3. This sealing gap causes undesired mixing of flue gas and air. To reduce the mixing of the flue gases and the air to be preheated, the sealing gap therefore tends to be made as small as possible. This can be achieved through manual or automatic adjustment devices. Automatic adjustment devices for sealing bars, however, are very difficult to make and cannot be retrofitted in many operating APHs due to lack of space.

FIG. 3 shows a partial sectional view of a rotor 3 and a brush seal 23 in accordance with the invention.

In the embodiment shown in FIG. 3, the brush seal 23 in accordance with the invention is retrofitted to an existing APH. In this case, the seal 23 in accordance with the invention is screwed to a conventional sealing bar 25. A sealing gap between sealing bar 25 and rotor 3 is marked with reference sign “S” in FIG. 3. The brush seal consists of a fixing bar 27, holding a multitude of bristles 29. It is self-evident that the brush seal 23 in accordance with the invention runs along the entire length of the sealing bar 25, even if FIG. 3 shows only a short section of the brush seal 23 in accordance with the invention.

As is well apparent from FIG. 3, the fixing bar 27 has a groove 31 to hold the bristles 29 in its lower part as shown in FIG. 3. The bristles 29 can be fixed in the groove 31 by means of pressing or welding, for example. As is well apparent from FIG. 3, the brush seal 23 in accordance with the invention bridges the sealing gap S completely, so that the leakage current between the flue gas and the air to be preheated is considerably reduced.

In the embodiment shown in FIG. 3, the bristles 29 and the movement direction of the rotor, indicated by arrow 5, form a 90° angle.

The bristles 29 can also be inclined as needed.

FIG. 4 shows a sectional view of a regenerative air preheater of the “Rothemühle” system with a stator 33, a first turn cap 35, and a second turn cap 37.

The air preheater as shown in FIG. 4 has a flue gas inlet 7, a flue gas outlet 9, an air inlet 15, and an air outlet 17, just as the air preheater shown in FIG. 1. As the stator 33, the flue gas inlet 7, the flue gas outlet 9, the air inlet 15, and the air outlet 17 are stationary, the first turn cap 35 and the second turn cap 37 ensure that flue gas and air to be preheated alternately flow over the heating elements of the stator 33. This type of construction is sufficiently known, such that a detailed description of the air conduction and the flue gas conduction in relation to the invention is not necessary.

FIG. 5 shows an exploded view of a part of a first turn cap 35. The upper part of the part of the first turn cap 35 shown in FIG. 5 collects the preheated air that has passed the stator 33 and conducts it to the air outlet 17 (not shown in FIG. 5: see FIG. 4). As the turn cap 35 turns during operation, a seal 39 is envisioned at the top end of the first turn cap 35. A sealing bar 25, which resembles the shape of a bone, is envisioned at the lower side of the first turn cap 35 as shown in FIG. 5. A brush seal 23 in accordance with the invention is fitted to this sealing bar 25. (Refer to FIG. 3 and its description for the construction of the brush seal 23 in accordance with the invention.)

1-8. (canceled)

9. A regenerative air preheater comprising:
a casing, said casing defining at least one flue gas inlet, at least one flue gas outlet, at least one air inlet, and at least one air outlet;
a rotor disposed within said casing;
at least one axial seal; and
at least one radial seal, said axial seal and radial seal disposed, structured, and dimensioned to separate flue gases from air being preheated, wherein said axial seal and/or said radial seal consists essentially of a brush seal having a fixing bar with a groove in which bristles are mounted.

10. The regenerative air preheater of claim 9, wherein said bristles of said brush seal are held in non-positive fit at or in said fixing bar.

11. The regenerative air preheater of claim 9, wherein said bristles of said brush seal are firmly bonded with or welded to said fixing bar.

12. The regenerative air preheater of claim 9, wherein said bristles of said brush seal form an angle between 90° and 30° with a direction of relative movement between said rotor and said brush seal.

13. The regenerative air preheater of claim 9, wherein said brush seals are manually or automatically adjustable.

14. The regenerative air preheater of claim 9, wherein said bristles of said brush seal are made of stainless steel, Haynes 25 alloy, or nickel-cobalt alloy.

15. The regenerative air preheater of claim 9, further comprising conventional seals, manually adjustable sealing bars or automatically adjustable sealing bars, in addition to said brush seals.

16. A regenerative air preheater comprising:
a casing, said casing defining at least one flue gas inlet, at least one flue gas outlet, at least one air inlet, and at least one air outlet;
a stator disposed within said casing;
a first turn cap disposed, structured, and dimensioned to connect at least one flue gas inlet, at least one air outlet, and said stator;
a second turn cap disposed, structured, and dimensioned to connect at least one flue gas outlet, at least one air inlet, and said stator; and
axial seals cooperating with said first turn cap and said second turn cap to separate flue gases from air being preheated, said axial seals consisting essentially of brush seals, each brush seal having a fixing bar with a groove in which bristles are mounted.

17. The regenerative air preheater of claim 16, wherein said bristles of said brush seal are held in non-positive fit at or in said fixing bar.

18. The regenerative air preheater of claim 16, wherein said bristles of said brush seal are firmly bonded with or welded to said fixing bar.

19. The regenerative air preheater of claim 16, wherein said bristles of said brush seal form an angle between 90° and 30° with a direction of relative movement between said stator and said brush seal.

20. The regenerative air preheater of claim 16, wherein said brush seals are manually or automatically adjustable.

21. The regenerative air preheater of claim 16, wherein said bristles of said brush seal are made of stainless steel, Haynes 25 alloy, or nickel-cobalt alloy.

22. The regenerative air preheater of claim 16, further comprising conventional seals, manually adjustable sealing bars or automatically adjustable sealing bars, in addition to said brush seals.
